(19) United States
(12) Patent Application Publication
(10) Pub. No.: US 2017/0303014 A1
(43) Pub. Date: Oct. 19, 2017

(54) SYSTEM FOR PROVIDING FUNCTIONALITY BASED ON SENSOR DATA

(71) Applicant: Karim Ghessassi, Parker, CO (US)

(72) Inventor: Karim Ghessassi, Parker, CO (US)

(21) Appl. No.: 15/492,740

(22) Filed: Apr. 20, 2017

Related U.S. Application Data
(63) Continuation-in-part of application No. 15/490,684, filed on Apr. 18, 2017, now abandoned.
(60) Provisional application No. 62/324,152, filed on Apr. 18, 2016.

(51) Int. Cl. H04Q 9/00; G06N 99/00; H04L 29/08

(52) U.S. Cl. CPC H04Q 9/00; H04L 67/30; G06N 99/005; H04Q 2209/10

(57) ABSTRACT

Disclosed is a system for providing at least one functionality based on sensor data. The system includes one or more sensors configured to generate an incoming sensor data. Further, the system includes a storage device configured to store multiple profiles associated with historical sensor data. Moreover, the system includes a processor communicatively coupled to each of the storage device and the one or more sensors. The processor is configured to compare the incoming sensor data with the multiple profiles. Further, the processor is configured to determine one or more states of the system based on a match between the incoming sensor data and one or more profiles of the multiple profiles.

### FIELD OF THE INVENTION

The present disclosure generally relates to the analysis of sensor data. More specifically, the present disclosure relates to a system to analyze sensor data generated by sensors for performing predictive analytics and system failure remediation.

### BACKGROUND OF THE INVENTION

We are moving towards an increasingly connected world. As connected technologies become more ubiquitous, the amount of data generated by these technologies is increasing exponentially. Smartphones, other smart devices, and the Internet of Things (IoT) devices enable individuals to track huge amounts of data. This data can be used to monitor various things from personal health to the state of a system. The ubiquity of data acquisition techniques has given rise to the concept of big data. The presence of such large amounts of data enable analytics programs to form correlations between disparate pieces of information. The use of analytics programs to process big data requires the use of novel protocols to identify trends in an effective manner. However, as the amount of generated data increases, the computational resources required to analyze this data also increases. This poses a challenge to quickly and intelligently analyze the generated data.

Therefore, there is a need for improved systems that require less computational resources required to process and react to incoming data sets.

### SUMMARY

Disclosed is a system for providing at least one functionality based on sensor data. The system includes one or more sensors configured to generate an incoming sensor data. Further, the system includes a storage device configured to store multiple profiles associated with historical sensor data. Moreover, the system includes a processor communicatively coupled to each of the storage device and the one or more sensors. The processor is configured to compare the incoming sensor data with the multiple profiles. Further, the processor is configured to determine one or more states of the system based on a match between the incoming sensor data and one or more profiles of the multiple profiles.

Further disclosed is a system for providing at least one functionality based on sensor data. The system includes one or more sensors configured to generate an incoming sensor data. Further, the system includes a storage device configured to store multiple profiles associated with historical sensor data. Moreover, the system includes a processor communicatively coupled to each of the storage device and the one or more sensors. The processor is configured to compare the incoming sensor data with the multiple profiles, predict one or more states of the system based on a match between the incoming sensor data and one or more profiles of the multiple profiles and generate a confidence associated with the one or more states. The confidence is based on a differential change between the incoming sensor data and the one or more profiles.

According to some aspects, a Real-time Sensor Analytics Platform is disclosed. The Real-time Sensor Analytics Platform may use machine learning algorithms to perform intelligent analytics on the data generated by a plurality of connected devices. Accordingly, the Real-time Sensor Analytics Platform becomes more effective as it analyzes more data. To accomplish this, the Real-time Sensor Analytics Platform creates profiles of historical data which it references against the incoming data in real-time. Similarities between historical data and real-time data are identified and used to generate predictions on the future state of the monitored system.

In addition to performing predictive analytics, the Real-time Sensor Analytics Platform incorporates predefined routines to address data sets which are determined to fit into specific categories. In this way, the Real-time Sensor Analytics Platform reduces the computational resources required to process and react to incoming data sets. Therefore, the Real-time Sensor Analytics Platform addresses the problem of increasingly large data sets.

### BRIEF DESCRIPTION OF THE DRAWINGS

FIG. 1 illustrates a block diagram of a system for providing at least one functionality based on sensor data according to some embodiments.

FIG. 2 illustrates a block diagram of a Real-time Sensor Analytics Platform for providing at least one functionality based on sensor data according to some embodiments.

FIG. 3 illustrates a flowchart of a method to implement the Real-time Sensor Analytics Platform in accordance with some embodiments.

FIG. 4 illustrates a flowchart of a rule implementation method in accordance with some embodiments.

FIG. 5 illustrates a flowchart of a predictive analysis method in accordance with some embodiments.

### DETAILED DESCRIPTION OF THE INVENTION

All descriptions are for the purpose of showing selected versions of the present invention and are not intended to limit the scope of the present invention.

Non-limiting and non-exhaustive embodiments of the present invention are described with reference to the preceding figures, wherein like reference numerals refer to like parts throughout the various views unless otherwise precisely specified.

In the description herein, general details of the present invention are provided in flow diagrams to provide a general understanding of the programming methods that will assist in an understanding of embodiments of the present invention. One skilled in the relevant art of programming will recognize, however, that the present invention can be practiced without one or more specific details, or in other programming methods. Referenced throughout this specification to “one embodiment” or “an embodiment” means that a particular feature, structure or characteristic described in connection with the embodiment is included in at least one embodiment of the present invention. Thus, the appearance of the phrases “in one embodiment” or “in an embodiment” in places throughout this specification are not necessarily all referring to the same embodiment. Furthermore, the particular features, structures, or characteristics may be combined in any suitable manner in one or more embodiments.

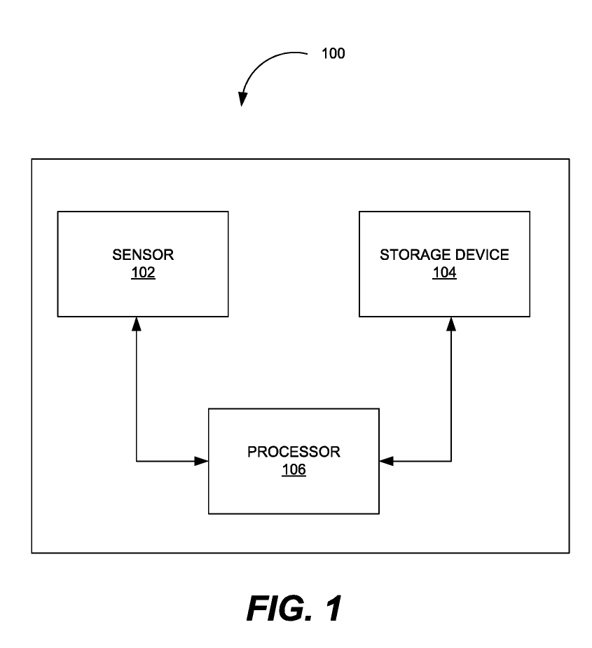

FIG. 1 illustrates a block diagram of a system 100 for providing at least one functionality based on sensor data according to some embodiments. The system 100 may include one or more sensors 102 configured to generate an incoming sensor data. Further, the system 100 may include a storage device 104 configured to store multiple profiles associated with historical sensor data. Each of the incoming sensor data and each profile associated with historical sensor data may correspond to a common time window.

Moreover, the system may include a processor 106 communicatively coupled to each of the storage device and the one or more sensors. The processor 106 may be configured to compare the incoming sensor data with the multiple profiles. Further, the processor 106 may be configured to determine one or more states of the system based on a match between the incoming sensor data and one or more profiles of the multiple profiles. The processor 106 may be configured to determine the one or more states based on machine learning.

In some embodiments, each of the one or more sensors 102, the storage device 104 and the processor 106 may be embedded in a single circuit board. One primary focus and intent of the present invention is in “Edge computing” applications where the system may be isolated from or periodically separated from external computer networks and systems. For example, the current system may be implemented in an environment such as, but not limited to, an airplane, an oil rig, or in a remote location where cloud computing or other communications with external computing systems is not possible. In such cases, the present invention provides the ability to monitor a system, make decisions based on the incoming sensor data, and execute machine learning processes in a closed system without external input. In some embodiments, the present invention is embedded in a closed system and does not communicate with any other computer networks or systems. In some embodiments, the present invention may be configured with the capability to communicate with external computer networks and systems when available, but can perform all desired functions independently of external input or communication. In some embodiments, the present invention may be configured to be constantly in electronic communication with a cloud computing network or other external computing system.

In some embodiments, the one or more states of the system may include a trigger state. Accordingly, the processor 106 may be configured to predict the trigger state.

The processor 106 may be further configured to generate a confidence associated with the one or more states. The confidence may be based on a differential change between the incoming sensor data and the one or more profiles.

The processor 106 may be further configured to perform one or more reactions based on the one or more states. The one or more reactions may include one or more pre-set actions comprising at least one of: shutting down of at least one module of the system; altering the state of at least one module of the system;

transmission of an alert to a remote device; transmission of a state change indicator to a remote device, wherein the system further comprises a communication engine configured to perform the transmission; modification of at least one module of the system; and altering the state of at least one module of the system. The processor 106 may be further configured to determine reaction efficacy information based on the one or more reactions, wherein the storage device 104 is further configured to store and the remediation efficacy information.

The processor 106 determining the one or more states may further include identification of one or more artifacts in the incoming sensor data, wherein the processor 106 may be further configured to perform one or more user-defined routines associated with the one or more artifacts. The processor 106 may be further configured to remove the one or more artifacts from the incoming sensor data to generate a conditioned sensor data and perform machine learning based on the conditioned sensor data.

The system 100 may further include a communication engine configured to receive the multiples profiles associated with historical data from a remote device. The multiples profiles may be created based on sensor data generated by a sensor comprised in the remote device, wherein a type of the sensor comprised in the remote device may be similar to a type of the one or more sensors 102 comprised in the system 100. The processor 106 may be further configured to generate a profile associated with the incoming sensor data, wherein the communication engine may be further configured to transmit the profile associated with the incoming sensor data to the remote device. The system 100 may further include a state sensor configured to detect a state of the system 100, wherein the processor 106 may be further configured to correlate the profile associated with incoming sensor data with the state of the system 100. The communication engine may be further configured to transmit indication of the state of the system 100 to the remote device. The state of the system 100 may include one or both of a failure state and a normal state.

The processor 106 may be further configured to normalize a data timeline corresponding to the incoming sensor data based on at least one data timeline corresponding to the historical sensor data.

According to some embodiments, the system 100 for providing at least one functionality based on sensor data may include the one or more sensors 102 configured to generate an incoming sensor data. The system 100 may also include the storage device 104 configured to store multiple profiles associated with historical sensor data. The system 100 may also include the processor 106 communicatively coupled to each of the storage device 104 and the one or more sensors 102. The processor 106 may be configured to compare the incoming sensor data with the multiple profiles; predict one or more states of the system 100 based on a match between the incoming sensor data and one or more profiles of the multiple profiles; and generate a confidence associated with the one or more states, wherein the confidence is based on a differential change between the incoming sensor data and the one or more profiles.

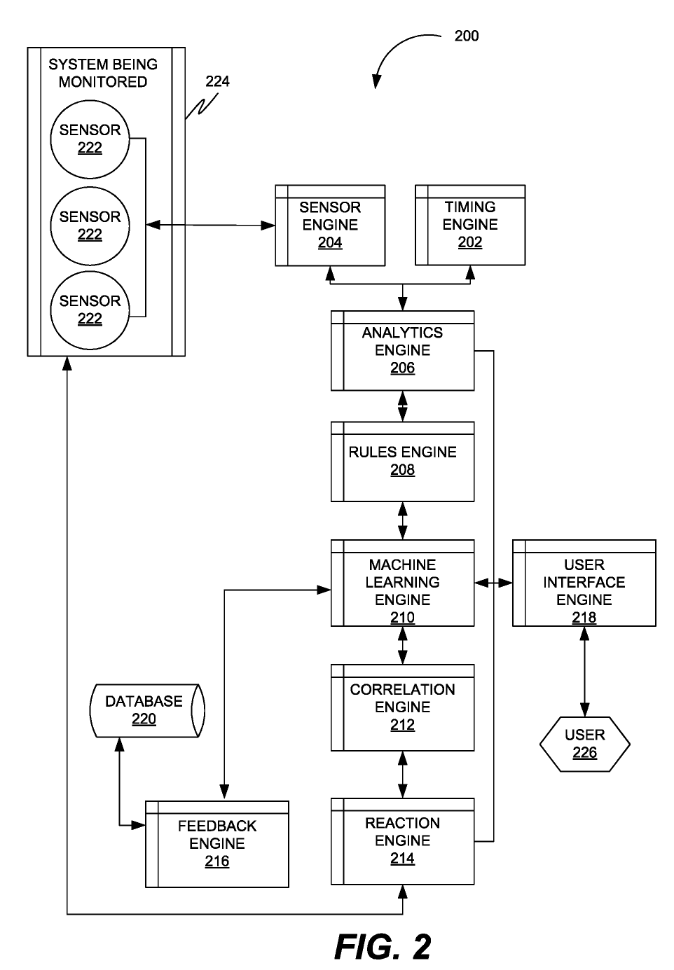

FIG. 2 illustrates a block diagram of a Real-time Sensor Analytics Platform 200 for providing at least one functionality based on sensor data according to some embodiments. The Real-time Sensor Analytics Platform 200 may include a timing engine 202, a sensor engine 204, an analytics engine 206, a rules engine 208, a machine learning engine 210, a correlation engine 212, a reaction engine 214, a feedback engine 216, a user interface (UI) engine 218, and a database 220. The term engine is used herein to refer to collections of programs which are grouped based upon function. Accordingly, each of the engines 202-218 may be a collection of computer programs including computer instructions which may be stored in the database 220 (similar to the storage device 104). Further, the engines 202-218 may be executed by a processor (similar to the processor 106). The sensor engine 204 may receive sensor data from one or more sensors 222 (similar to the one or more sensors 102). The Real-time Sensor Analytics Platform 200 may be configured to monitor a system 224 comprising the one or more sensors 222. The Real-time Sensor Analytics Platform 200 may be configured

to correlate the data from the one or more sensors 222 to a collection of historically relevant data, and to perform predictive analytics based upon the derived correlation.

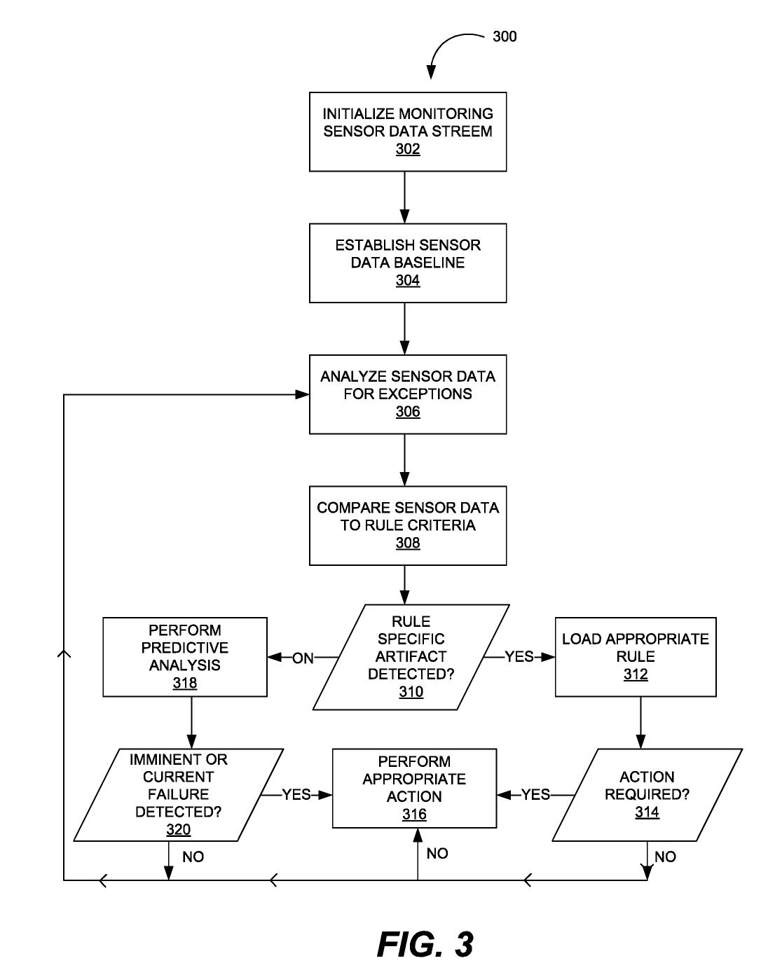

FIG. 3 illustrates a flowchart of a method 300 to implement the Real-time Sensor Analytics Platform 200 in accordance with some embodiments. At 302, the Real-time Sensor Analytics Platform 200 initializes monitoring and recording the data from the one or more sensors 222 along a normalized timeline. The timing engine 202 may function as a synchronization system by which all collected sensor data is metered. The data from one or more sensors 222 may be processed by the sensor engine 204. At 304, the sensor engine 204 may designate a data stream for each sensor (in the one or more sensors 222) as a unique dimension (a baseline) of time-relevant data. Therefore, the data stream provided by each sensor forms a single dimension of the overall dataset being collected over a period of time. The timing engine 202 and sensor engine 204 may serve as data acquisition modules which give dimensionality to the data being analyzed by the Real-time Sensor Analytics Platform 200.

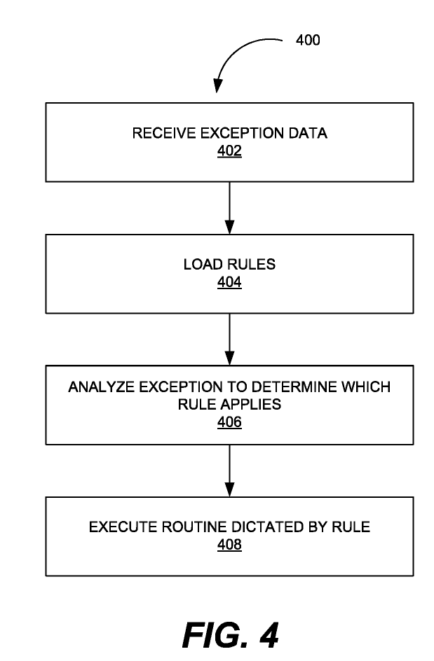

Then, the acquired sensor data is passed from the sensor engine 204 to the analytics engine 206, where the data may be organized into trends over a normalized timeline. At 306, the analytics engine 206 may perform preliminary analysis of received sensor data to identify irregularities (or exceptions) in the sensor output. Therefore, the analytics engine 206 may identify faults, anomaly, problems, exceptions, irregularities, and similar forms of relevant data. These identified artifacts are then passed to the rules engine 208. At 308, the rules engine 208 may compare the identified artifacts (and the sensor data) to rule criteria. If a rule specific artifact (or an anomaly) is detected at 310, then the rules engine 208 loads rules at 312. The rules may include user-defined routines. Then, at 314, the rules engine 208 may determine an appropriate rule based on the detected rule specific artifact. Next, at 316, the rules engine 208 executes the appropriate rule. This is explained in further detail in conjunction with FIG. 4 below.

Further, the rules engine 208 may function as an intermediary failure remediation system between the analytics engine 206 and the machine learning engine 210. The rules engine 208 may execute rules that have been user defined and do not require the Real-time Sensor Analytics Platform 200 to employ the reaction engine 214. In an alternate embodiment, the rules engine 208 may condition the data output by the analytics engine 206 to remove unwanted artifacts. In this embodiment, the conditioned data may then be passed to the machine learning engine 210.

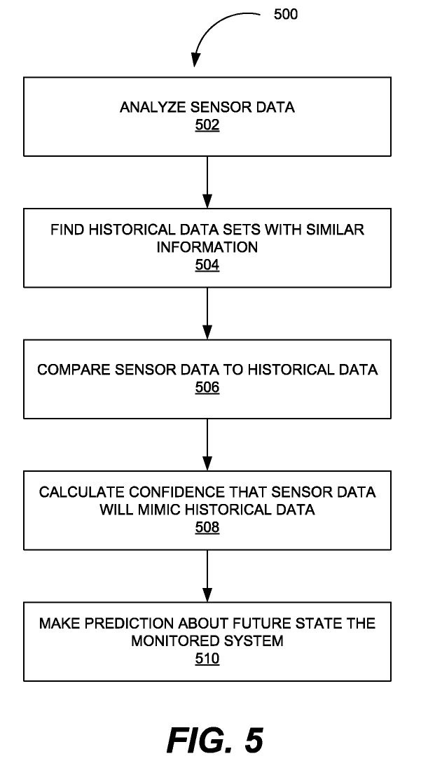

In the preferred embodiment of the present invention, unaltered data from the analytics engine 206 may be passed from the rules engine 208 to the machine learning engine 210. If a rule specific artifact (or an anomaly) is not detected at 310, then the rules engine 208 may pass the sensor data (the identified artifacts) to the machine learning engine 210. Then, at 318, the machine learning engine 210 may compare the sensor data (the identified artifacts) to historical records of data to determine any similarities to make predictions about the future state of the system 224 being monitored. Therefore, the machine learning engine 210 may establish a differential change relationship between sensor data that is stored within the database 220 and the sensor data acquired within a given time window. This is explained in further detail in conjunction with FIG. 5 below. This relationship indicates the confidence with which the machine learning engine 210 may predict the state of the system 224 being monitored. More particularly, the smaller the differential change between the current sensor data and the historical data set, indicates a higher prediction confidence. The differential change relationship, predictive analysis, and confidence factor generated by the machine learning engine 210 are then passed to the correlation engine 212.

Then, at 320, the correlation engine 212 may analyze the incoming sensor data and the information passed from the machine learning engine 210 to determine if the predicted future state matches the current state of the system 224 being monitored. The correlation engine 212 may generate a contextual analysis of incoming data to determine if a system failure is impending. If the correlation engine 212 determines that the system 224 being monitored is going to fail, or has already failed, it then passes the appropriate data to the reaction engine 214 which may execute the failure remediation routines at 316. Conversely, if no system failure is occurring, the correlation engine 212 passes the incoming data to the feedback engine 216 and the method 300 may go back to the step 306.

The reaction engine 214 may execute failure remediation routines based upon the data output of the correlation engine 212. The failure remediation routines may include, but are not limited to: shutting down parts of the system 224 being monitored, alerting users, modifying the operation of various system modules. The reaction engine 214 may then pass the failure remediation data, including efficacy information, to the feedback engine 216 and the method 300 may go back to the step 306.

The feedback engine 216 may process all data flowing through the Real-time Sensor Analytics Platform 200 to train the machine learning engine 210. Accordingly, incoming sensor data, predictive analysis, system failure information, failure remediation efficacy, and anomaly data may be stored in the database 220 and may be used to generate more accurate future predictions. Further, the feedback engine 216 may organize the data generated by the system 224 being monitored into packets which are accessible during real-time analysis.

Further, the UI engine 218 may be tasked with relaying information between a user 226 and the Real-time Sensor Analytics Platform 200. The UI engine 218 may enable the user 226 to specify the user defined routines to be executed by the rules engine 208. Additionally, the UI engine 218 may generate notifications that indicate pertinent information; such as the state of the system, pending or occurring failures, incoming sensor data trends. Furthermore, the UI engine 218 may enable the user 226 to specify sections of data that should be printed out, or contain valuable information.

FIG. 4 illustrates a flowchart of a rule implementation method 400 in accordance with some embodiments. At 402, the rules engine 208 receives from the analytics engine 206 the identified faults, anomaly, problems, exceptions, irregularities, and similar forms of relevant data. At 404, the rules engine 208 may load rules. Then, at 406, the rules engine 208 may analyze the identified artifacts (and the sensor data) to determine which rule applies. Next, at 408, the rules engine 208 executes the determined rule.

FIG. 5 illustrates a flowchart of a predictive analysis method 500 in accordance with some embodiments. At 502, the machine learning engine 210 analyzes the data received from the rules engine 208. Then at 504, the machine learning engine 210 may find historical data sets with similar information as the data received from the rules engine 208. Next, at 506, the machine learning engine 210 may compare the sensor data (the identified artifacts) to historical records of data to determine similar data sets. Thereafter, at 508, the machine learning engine 210 may calculate a confidence that the sensor data may mimic historical data. The confidence may be calculated by establishing a differential change relationship between historical data and the sensor data acquired within a given time window. Then, at 510, the machine learning engine 210 may predict a future state of the system 224 being monitored

### Exemplary Embodiments

According to some embodiments of the present disclosure, a system for providing at least one functionality based on sensor data. The system may include one or more sensors configured to generate an incoming sensor data. Further, the system may include a storage device configured to store multiple profiles associated with historical sensor data.

Moreover, the system may include a processor communicatively coupled to each of the storage device and the one or more sensors. The processor may be configured to compare the incoming sensor data with the multiple profiles and determine one or more states of the system based on a match between the incoming sensor data and one or more profiles of the multiple profiles. The determination may be performed based on machine learning. Each of the incoming sensor data and each profile associated with historical sensor data may correspond to a common time window. The processor may be further configured to normalize a data timeline corresponding to the incoming sensor data based on at least one data timeline corresponding to the historical sensor data.

In some embodiments, the one or more states of the system may include a trigger state, wherein the determination may include prediction of the trigger state.

Further, the processor may be configured to generate a confidence associated with the one or more states. The confidence may be based on a differential change between the incoming sensor data and the one or more profiles.

In some embodiments, the determination of the one or more states may include identification of one or more artifacts in the incoming sensor data, wherein the processor may be further configured to perform one or more user-defined routines associated with the one or more artifacts. The processor may be further configured to remove the one or more artifacts from the incoming sensor data to generate a conditioned sensor data and perform machine learning based on the conditioned sensor data.

In further embodiments, the processor may be further configured to perform one or more reactions based on the one or more states. The one or more reactions may include one or more pre-set actions comprising at least one of shutting down of one or more modules of the system; transmission of an alert to a remote device, wherein the system further include a communication engine configured to perform the transmission; and modification of one or more modules of the system. The processor may be further configured to determine reaction efficacy information based on the one or more reactions, wherein the storage device is further configured to store and the remediation efficacy information.

In further embodiments, the system for providing at least one functionality based on sensor data may include a communication engine configured to receive the multiple profiles associated with historical data from a remote device. The multiple profiles may be created based on sensor data generated by a sensor comprised in the remote device, wherein a type of the sensor comprised in the remote device is similar to a type of the one or more sensors comprised in the system. The processor may be further configured to generate a profile associated with the incoming sensor data, wherein the communication engine may be further configured to transmit the profile associated with the incoming sensor data to the remote device. The system for providing at least one functionality may also include a state sensor configured to detect a state of the system, wherein the processor may be further configured to correlate the profile associated with incoming sensor data with the state of the system, wherein the communication engine may be further configured to transmit indication of the state of the system to the remote device. The state of the system may include at least one of a failure state and a normal state.

Each of the one or more sensors, the storage device and the processor may be embedded in a single circuit board.

According to some embodiments of the present disclosure, a system for providing at least one functionality based on sensor data may be disclosed. The system may include one or more sensors configured to generate an incoming sensor data. The system may also include a storage device configured to store multiple profiles associated with historical sensor data. Further, the system may include a processor communicatively coupled to each of the storage device and the one or more sensors, wherein the processor is configured to compare the incoming sensor data with the multiple profiles; predict one or more states of the system based on a match between the incoming sensor data and one or more profiles of the multiple profiles; generate a confidence associated with the one or more states, wherein the confidence is based on a differential change between the incoming sensor data and the one or more profiles.

Although the invention has been explained in relation to its preferred embodiment, it is understood that many other possible modifications and variations can be made without departing from the spirit and scope of the invention as herein described.

I claim:

1. A system for providing at least one functionality based on sensor data, the system comprising:
at least one sensor configured to generate an incoming sensor data;
a storage device configured to store a plurality of profiles associated with historical sensor data;
a processor communicatively coupled to each of the storage device and the at least one sensor, wherein the processor is configured to:
compare the incoming sensor data with the plurality of profiles; and
determine at least one state of the system based on a match between the incoming sensor data and at least one profile of the plurality of profiles.

2. The system of claim 1, wherein the at least one state of the system comprises a trigger state.

3. The system of claim 2, wherein the determination comprises prediction of the trigger state.

4. The system of claim 1, wherein the processor is further configured to perform at least one reaction based on the at least one state.

5. The system of claim 4, wherein the at least one reaction comprises at least one pre-set action comprising at least one of:
altering a state of at least one module of the system;
transmission of a state change indicator to a remote device, wherein the system further comprises a communication engine configured to perform the transmission; and
altering the state of at least one module of the system.

6. The system of claim 5, wherein the processor is further configured to determine reaction efficacy information based on the at least one reaction, wherein the storage device is further configured to store and the remediation efficacy information.

7. The system of claim 1, wherein the processor is further configured to generate a confidence associated with the at least one state.

8. The system of claim 7, wherein the confidence is based on a differential change between the incoming sensor data and the at least one profile.

9. The system of claim 1, wherein the determination is performed based on machine learning.

10. The system of claim 1, wherein determination of the at least one state comprises identification of at least one artifact in the incoming sensor data, wherein the processor is further configured to perform at least one user-defined routine associated with the at least one artifact.

11. The system of claim 10, wherein the processor is further configured to:
remove the at least one artifact from the incoming sensor data to generate a conditioned sensor data; and
perform machine learning based on the conditioned sensor data.

12. The system of claim 1, wherein the processor is further configured to normalize a data timeline corresponding to the incoming sensor data based on at least one data timeline corresponding to the historical sensor data.

13. The system of claim 1, wherein each of the incoming sensor data and each profile associated with historical sensor data correspond to a common time window.

14. The system of claim 1 further comprising a communication engine configured to receive the plurality of profiles associated with historical data from a remote device.

15. The system of claim 14, wherein the plurality of profiles is created based on sensor data generated by a sensor comprised in the remote device, wherein a type of the sensor comprised in the remote device is similar to a type of the at least one sensor comprised in the system.

16. The system of claim 14, wherein the processor is further configured to generate a profile associated with the incoming sensor data, wherein the communication engine is further configured to transmit the profile associated with the incoming sensor data to the remote device.

17. The system of claim 16 further comprising a state sensor configured to detect a state of the system, wherein the processor is further configured to correlate the profile associated with incoming sensor data with the state of the system, wherein the communication engine is further configured to transmit indication of the state of the system to the remote device.

18. The system of claim 17, wherein the state of the system comprises at least one of a failure state and a normal state.

19. The system of claim 1, wherein each of the at least one sensor, the storage device and the processor is embedded in a single circuit board.

20. A system for providing at least one functionality based on sensor data, the system comprising:
at least one sensor configured to generate an incoming sensor data;
a storage device configured to store a plurality of profiles associated with historical sensor data;
a processor communicatively coupled to each of the storage device and the at least one sensor, wherein the processor is configured to:
compare the incoming sensor data with the plurality of profiles;
predict at least one state of the system based on a match between the incoming sensor data and at least one profile of the plurality of profiles; and
generate a confidence associated with the at least one state, wherein the confidence is based on a differential change between the incoming sensor data and the at least one profile.
